(19) United States
(12) Patent Application Publication
(10) Pub. No.: US 2013/0092101 A1
(43) Pub. Date: Apr. 18, 2013

(54) PET LEASH

(71) Applicant: Jason Sylvanowicz, Waltham, MA (US)

(72) Inventor: Jason Sylvanowicz, Waltham, MA (US)

(21) Appl. No.: 13/195,696

(22) Filed: Aug. 1, 2011

(51) Int. Cl. A01K 27/00

(52) U.S. Cl. CPC A01K 27/003
USPC 119/795

(57) ABSTRACT

The WalleyLead is designed with comfort and safety in mind for the owner and the dog. The lead is hand crafted from strong double braided nylon rope, high quality snap hooks, and a moveable foam grip. Walleyleads are available in three unique lengths based on the size of your dog and seven colors. The shorter length allows for easier control of the dog in high traffic areas. The grip is more comfortable for the owner and the lead always provides the consistent amount of correction for the dog—an integral part of training a dog to behave while walking on a leash.

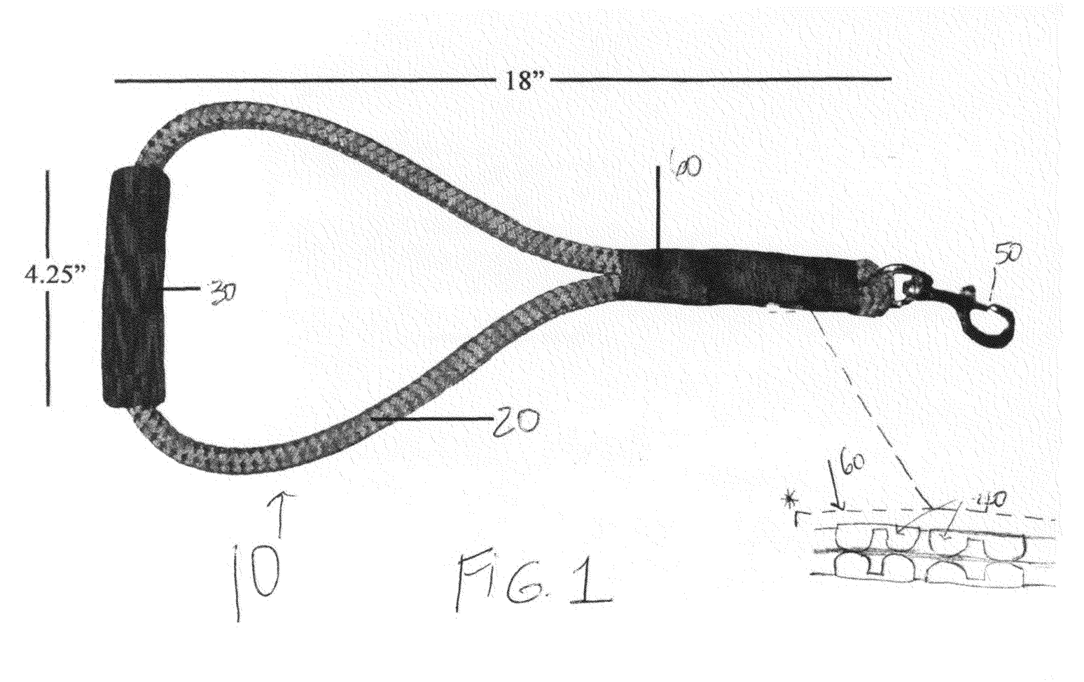

### BRIEF DESCRIPTION OF THE DRAWINGS

The FIGURE illustrates a perspective front view of the pet leash according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a pet leash that provides the user with the leverage control of the leash keeping the pet closer to the owner's side.

The standard length of the current leash is between 48-72 inches. The current leashes are designed based only on the pet and not on the owner of the pet. Usually, the pet owners will wrap the leash around one of their hands to keep the pet close to them.

The pet leash 10 of the present invention may eliminate the above problem by keeping the pet closer to the owner's side. The pet leash 10 of the present invention may keep the pet with a shorter and stronger leash.

The pet leash 10 comprises a cord 20 folded in two. A handle 30 may slide into one of the ends of the folded cord 20 and a hook 50 may be attached to the other end of the cord 20.

The cord 20 may be made of a strong material. In one embodiment, the cord 20 may be a rope or chain. In one embodiment, the rope may be a double-braided nylon rope. The cord 20 may have high tension strength. In one embodiment, the cord 20 may have tension strength of approximately 6,500 lbs. The cord may be available in a plurality of colors. In one embodiment, the cord 20 may have different patterns. In one embodiment, the pattern may be dots, squares, rectangles, triangles, flowers, or lines. In one embodiment, the cord 20 may be a ½ inch thick, double-braided nylon rope. In one embodiment, the cord may weigh approximately 6.3 lbs per 100 feet.

The cord 20 may be of a length that allows the pet owner to 10 handle the pet. In one embodiment, the cord 20 may be 18 inches long.

The handle 30 may slide onto the cord 20. The handle 30 may be made of a light weight flexible material that permits the soft gripping of the handle 30. In one embodiment, the handle 30 may be made of foam. The handle 30 may be of a shape that allows the pet owner to comfortably grab the handle. The size of the handle 30 depends on the customer's preference. In one embodiment, the handle 30 may be approximately 4.25 inches thick.

In one embodiment, the pet leash 10 may include at least two clamps 40. The clamps 40 may tie the folded cord together. In one embodiment the clamps may be rope clamps. In one embodiment, the clamps 40 may be zinc plated over sheet steel. In one embodiment, a hook 50 may be attached to one of the ends of the pet leash 10. In one embodiment, the hook 50 may be a snap hook. In one embodiment, the hook may be nickel plated.

In one embodiment, the pet leash 10 may include a cover 60 to hold the clamps 40 in place. In one embodiment, the cover 60 may be rubber heat shrink. In one embodiment, the rubber heat shrink is over the fabric tape which is heat-shrunk into the pet leash 10 to finish and seal the connection with the clamps 40.

The pet leash 10 of the present invention may be used like a normal leash. The difference is that the handle may give the user the leverage control of the leash. In addition, the pet leash of the present invention may eliminate the concept of wrapping the leash around your hand to gain leverage on the dog.

It should be understood, of course, that the foregoing relates to exemplary embodiments of the invention and that modifications may be made without departing from the spirit and scope of the invention as set forth in the following claims.

We claim:

1. A pet leash comprising:
a cord folded in two, the folded cord including a first end and a second end;
a handle attached to the first end of the folded rope; and a hook attached to the second end of the folded cord.
